(19) United States
(12) Patent Application Publication
(10) Pub. No.: US 2006/0215318 A1
(43) Pub. Date: Sep. 28, 2006

(54) Magnetic recording head and method of manufacturing the same

(75) Inventors: Hoo-san Lee, Osan-si (KR); Yong-su Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/387,928

(22) Filed: Mar. 24, 2006

(30) Foreign Application Priority Data
Mar. 24, 2005 (KR) 10-2005-0024569

(51) Int. Cl. G11B 5/147

(52) U.S. Cl. 360/126

(57) ABSTRACT

A magnetic recording head and a method of manufacturing the same are provided. The magnetic recording head has a stacked structure including a main pole and a return pole. The stacked structure includes a first insulation layer having a stepped portion on one surface, a first magnetic portion having a shape of a vertical thin film that contacts a riser of the stepped portion, and a second magnetic layer disposed to be insulated from the first magnetic portion. The method of manufacturing the magnetic recording head includes forming the first insulation layer having a stepped portion on one surface, forming a magnetic thin film on the first insulation layer along the stepped portion, and forming the main pole by etching the magnetic thin film during a predetermined period of time until only a vertical thin film portion of the magnetic thin film that contacts a riser of the stepped portion remains.

### CROSS-REFERENCE TO RELATED PATENT APPLICATION

This application claims priority from Korean Patent Application No. 10-2005-0024569, filed on Mar. 24, 2005, in the Korean Intellectual Property Office, the disclosure of which is incorporated herein in its entirety by reference.

### BACKGROUND OF THE INVENTION

1. Field of the Invention

The present invention relates to a magnetic recording head and a method of manufacturing the same, and more particularly, to a magnetic recording head having a thin film stacked structure including a main pole and a return pole, and a method of manufacturing the magnetic recording head.

2. Description of the Related Art

Magnetic recording heads are generally divided into longitudinal magnetic recording heads and perpendicular magnetic recording heads according to whether the magnetic polarization of a domain is longitudinal or perpendicular. Especially, perpendicular magnetic recording heads are suitable for improving the data recording density. Apparatuses that write data to magnetic recording media, namely, discs, are called magnetic recording heads. Magnetic recording heads include a main pole which applies a magnetic field to a magnetic recording medium and a return pole to which the applied magnetic field returns. Magnetic recording heads each have a thin film stacked structure to be made compact.

In order to increase the magnetic recording density, the track width of a disc-type magnetic recording medium should be narrowed. To do this, it is important to decrease the width of the main pole. However, conventional magnetic recording heads having a stack structure have a limit in reducing the width of the main pole due to a restriction upon a technique of manufacturing the stacked type magnetic recording heads.

A stacked structure for conventional magnetic -recording heads and a method of manufacturing the same will now be described briefly with reference to FIGS. 1 through 3D. FIG. 1 is a schematic diagram showing a relationship between a trapezoid main pole 10 of a conventional magnetic recording head and the track width of a magnetic recording medium. When a recording surface of the magnetic recording medium and the horizontal cross-section of the magnetic recording head are viewed vertically, the main pole 10 is approximately trapezoid. The trapezoid main pole 10 has an advantage in that writing of bit data to a selected track does not affect a track adjacent to the selected track even when a skew angle S is maximum. When the trapezoid main pole 10 is included in the magnetic recording head as described above, the track width of the magnetic recording medium depends upon a width of the main pole 10 that corresponds to a long side 10b of the trapezoid main pole 10. In other words, the maximum track width W1 when the skew angle S is 0° is equal to the length of the longer side 10b of the trapezoid which is the cross-section of the main pole 10.

FIG. 2 is a cross-section of a conventional magnetic recording head having a stacked structure. The cross-section of FIG. 2 is a horizontal cross-section of the magnetic recording head which faces a magnetic recording medium. A first insulation layer 21, a second insulation layer 22, a third insulation layer 23, and a return pole layer 30 are sequentially stacked. A slit having a trapezoid cross-section is formed in the second insulation layer 22 and is filled with a magnetic material to thereby form the trapezoid main pole 10.

FIGS. 3A through 3D are cross-sectional views illustrating a method of manufacturing the conventional magnetic recording head of FIG. 2. As shown in FIG. 3A, the first insulation layer 21 and a main pole layer 10′ are sequentially stacked, and a photoresist pattern 80 is formed on a stack of the first insulation layer 21 and a main pole layer 10′. The photoresist pattern 80 is a line pattern having a predetermined width. A minimum width of the photoresist pattern 80 depends upon a photolithography technique for forming the photoresist pattern 80.

Thereafter, as shown in FIG. 3B, the main pole layer 10′ is etched until the first insulation layer 21 is exposed, thereby forming the trapezoid main pole 10 below the photoresist pattern 80. The greater width of the main pole 10 is equal to the width of the photoresist pattern 80.

Then, as shown in FIG. 3C, the second insulation layer 22 is formed on the first insulation layer 21. The second insulation layer 22 may be formed by depositing an insulative material on the entire surface of the resultant structure until both sides of the main pole 10 are filled with the insulative material and removing the photoresist pattern 80 and an insulation portion formed on the trapezoid main pole 10 using a lift-off method. Alternatively, the second insulation layer 22 may be formed by first removing the photoresist pattern 80 using a stripper, depositing the insulative material on the resultant structure, and polishing an insulation portion formed on the trapezoid main pole 10. Next, as shown in FIG. 3D, the third insulation layer 23 is formed on the main pole 10 and the second insulation layer 22. The return pole layer 30 is formed of a magnetic material on the third insulation layer 23.

However, the photoresist pattern 80 can only have a width of about 100 nm when existing photolithography equipment is used. In other words, since the width of the main pole 10 depends upon the width W₁ of the photoresist pattern 80 as described above, the conventional stacked structure cannot make the width W₁ of the magnetic recording medium lower than 100 nm. There remains a demand for a structure for a magnetic recording medium capable of narrowing the track of a magnetic recording head and a method of manufacturing the magnetic recording head.

### SUMMARY OF THE INVENTION

The present invention provides a magnetic recording head having a new stacked structure which can reduce the track width of a magnetic recording medium and a method of manufacturing the magnetic recording head.

According to an aspect of the present invention, the track width of a magnetic recording medium may be determined by the film thickness which can be more easily controlled as compared with photolithography.

According to an aspect of the present invention, there is provided a magnetic recording head having a stacked structure including a main pole and a return pole. The stacked structure includes a first insulation layer having a stepped portion on one surface, a first magnetic portion having a shape of a vertical thin film that contacts a riser of the stepped portion, and a second magnetic layer disposed to be insulated from the first magnetic portion.

The vertical thin film shape denotes a portion of a thin film formed with a nearly uniform thickness along the surface of the stepped portion 411 formed nearly perpendicularly with respect to a reference surface on which the stacked structure of a magnetic recording medium is formed. The first insulation layer may be a layer formed on a substrate using a method, such as, deposition.

The first magnetic portion serves as a main pole which applies a magnetic field to a magnetic recording medium. The second magnetic layer serves as a return pole to which the applied magnetic field returns. The magnetic field received from the first magnetic portion as the main pole passes through a recording layer of the magnetic recording medium and a soft underlayer and returns to the second magnetic layer as the return pole. During this process, an area of the recording layer that corresponds to the first magnetic portion having a high magnetic flux density is magnetically polarized to an upward or downward pole, whereby bit data is stored in the magnetically polarized area.

According to another aspect of the present invention, there is provided a method of manufacturing a magnetic recording head having a stacked structure including a main pole and a return pole, the method including: forming a first insulation layer having a stepped portion on one surface; forming a first magnetic layer, which is a magnetic thin film, on the first insulation layer along the stepped portion; forming a first magnetic portion by etching the first magnetic layer during a predetermined period of time until a horizontal portion of the first magnetic layer is removed and only a vertical thin film portion of the first magnetic layer that contacts the riser of the stepped portion remains; forming a second insulation layer by depositing an insulative material on upper surfaces of the first insulation layer and the first magnetic portion and polishing the insulative material until the upper surface of the first magnetic portion is exposed; and sequentially stacking the third insulation layer and the second magnetic layer on the upper surface of the first magnetic portion.

The first insulation layer may be formed according to a selective etching method using a photoresist mask. The stacking of the insulation layers and the magnetic layers may be achieved using a general thin film stacking method.

### BRIEF DESCRIPTION OF THE DRAWINGS

The above and other features and advantages of the present invention will become more apparent by describing in detail exemplary embodiments thereof with reference to the attached drawings, in which:

FIG. 1 is a schematic diagram showing a relationship between a trapezoid main pole of a conventional magnetic recording head and the track width of a magnetic recording medium;

FIG. 2 is a cross-section of a conventional magnetic recording head having a stacked structure;

FIGS. 3A through 3D are cross-sectional views illustrating a method of manufacturing the conventional magnetic recording head of FIG. 2;

FIG. 4 is a cross-section of a stacked structure for a magnetic recording head according to an exemplary embodiment of the present invention;

FIGS. 5A through 5D are cross-sections illustrating a method of manufacturing the magnetic recording head of FIG. 4, according to an exemplary embodiment of the present invention;

FIG. 6A is a cross-section illustrating a method of forming an insulation layer having a stepped portion, according to an exemplary embodiment of the present invention;

FIG. 6B is a cross-section illustrating a method of forming the insulation layer having a stepped portion, according to another exemplary embodiment of the present invention; and

FIG. 7 is a cross-section of a stacked structure for a magnetic recording head according to another exemplary embodiment of the present invention.

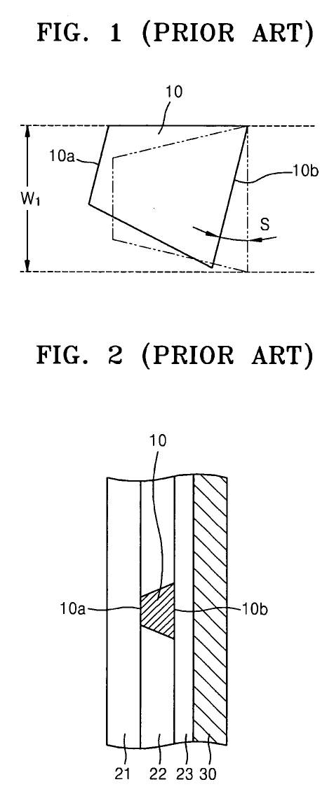

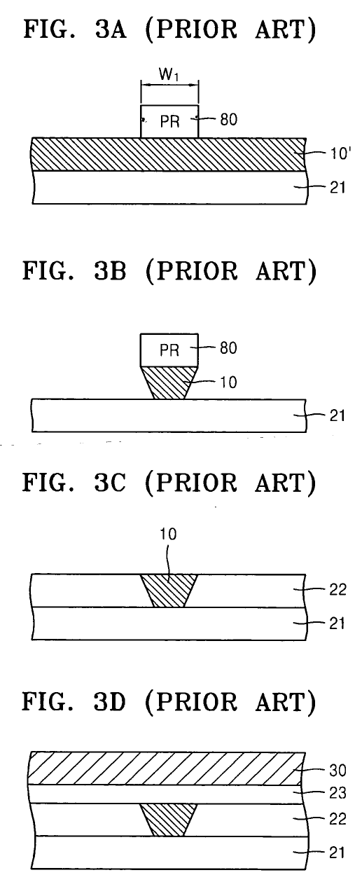

### DETAILED DESCRIPTION OF ILLUSTRATIVE NON-LIMITING EMBODIMENTS OF THE INVENTION

The present invention will now be described more fully with reference to the accompanying drawings, in which exemplary embodiments of the invention are shown. In the drawings, like reference numerals denote like elements or portions, and the thicknesses or widths of layers and regions may be exaggerated for clarity.

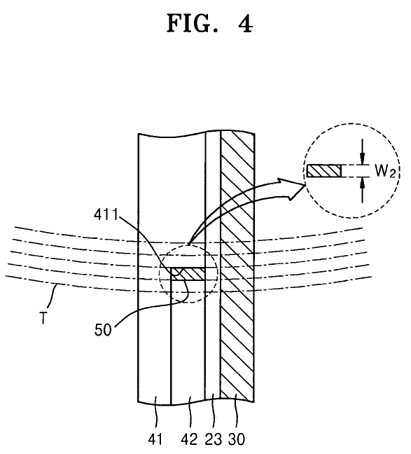

FIG. 4 is a cross-section of a stacked structure for a magnetic recording head according to an exemplary embodiment of the present invention. Referring to FIG. 4, the stacked structure includes a first insulation layer 41 having a stepped portion 411 on its one side and a first magnetic portion 50 contacting a riser of the stepped portion 411. The first magnetic portion 50 has a shape of a vertical thin film. The vertical thin film shape denotes a portion of a thin film formed with a nearly uniform thickness along the surface of the stepped portion 411 formed nearly perpendicularly with respect to a reference surface on which the stacked structure of a magnetic recording medium is formed.

The stacked structure further includes a second magnetic layer 30 insulated from the first magnetic portion 50. The first magnetic portion 50 serves as a main pole, and the second magnetic layer 30 serves as a return pole. The first magnetic portion 50 may be insulated from the second magnetic layer 30 using a second insulation layer 42 and a third insulation layer 23. The second insulation layer 42 is formed on a lower tread of the stepped portion 411 of the first insulation layer 41 to have the same height as the first magnetic portion 50. The third insulation layer 23 is formed between the upper surface of the first magnetic portion 50 and the second magnetic layer 30. The third insulation layer 23 serves as a write gap.

The insulation between the first magnetic portion 50 and the second magnetic layer 30 is not only achieved by using the above components but also may be achieved by using other various methods. For example, the second magnetic layer 30 may be disposed on a side of the first insulation layer 41 opposite to the first magnetic portion 50 so that the first insulation layer 41 can serve as a write gap.

A magnetic recording apparatus including the magnetic recording head of FIG. 4 makes a selected track of a magnetic recording medium proceed in a direction perpendicular to the direction in which the first magnetic portion 50 of the magnetic recording head is stacked. A width W₂ of a track T of the magnetic recording medium depends on the thickness of the thin film of the first magnetic portion 50. In other words, the thickness by which the first magnetic portion 50 is deposited on the first insulation layer 41 corresponds to the width W₂ of the track T of the magnetic recording medium.

To form a thin film having a thickness of several tens of nanometers to several sub-nanometers is possible even by using a conventional thin film forming technique. Hence, a magnetic recording head and a magnetic recording apparatus according to the present invention can write magnetic data to a magnetic recording medium while making a very narrow track of about subnanometers to several tens of nanometers. This means that a magnetic recording apparatus that can provide information storage with a level of a tera bit (Tb) per square inch (in²) using the magnetic recording head according to an exemplary embodiment of the present invention can be obtained.

The first magnetic portion 50 and the second magnetic layer 30 may be formed of a soft magnetic material that is magnetized by an external magnetic field generated by an electromagnetic induction or the like. The magnetic recording head according to exemplary embodiments of the present embodiment may use a material, such as, permalloy (NiFe) generally used in the conventional art, but is not limited to this exemplary material. However, because the first magnetic portion 50 serves as a main pole having a narrow cross-section on which a magnetic field is concentrated, it may be formed of a material having a greater saturation magnetic flux density (Bs) compared to the second magnetic layer 30.

The first, second, and third insulation layers 41, 42, and 23 may be formed of an insulative material. Oxide, such as, Al₂O₃, may usually be used as the insulative material. Other various materials, such as oxide and nitride that are generally used as an insulative material in the conventional art, may also be used, but is not limited to these exemplary material.

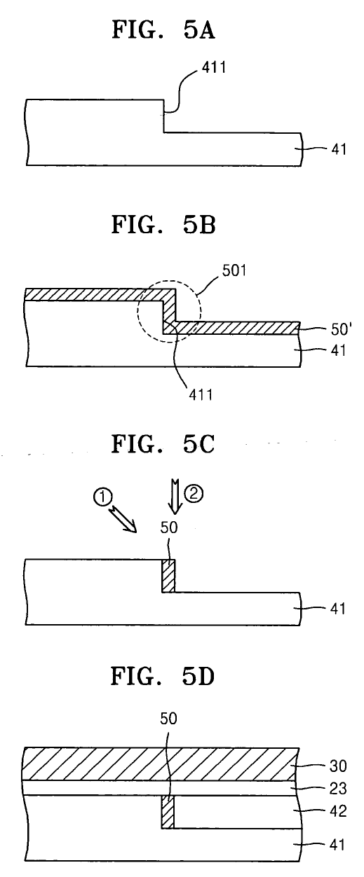

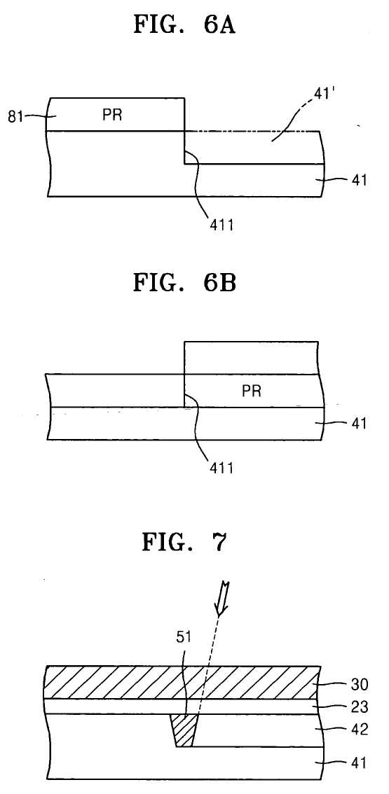

FIGS. 5A through 5D are cross-sections illustrating a method of manufacturing the magnetic recording head of FIG. 4, according to an exemplary embodiment of the present invention. First, as shown in FIG. 5A, the first insulation layer 41 having the stepped portion 411 on one surface is formed. The stepped portion 411 may be formed by etching an insulation layer portion 41 using a photoresist mask 81 as an etch mask (see FIG. 6A). Alternatively, the stepped portion 411 may be formed by forming a photoresist mask on a portion prearranged as a lower tread of the stepped first insulation layer 41, depositing an insulative material on the resultant structure to form an upper tread for the stepped first insulation layer 41, and removing the photoresist mask and the insulative material formed thereon using the lift-off method (see FIG. 6B).

Next, as shown in FIG. 5B, a first magnetic layer 50, which is a magnetic thin film, is formed on the first insulation layer 41 along the stepped portion 411. As described above, a soft magnetic material, such as, permalloy (NiFe), but not limited to such, is suitable to form the first magnetic layer 50. The magnetic thin film may be formed using a general thin film forming technique, such as but not limited to, a sputtering technique, a vacuum evaporation technique, an electric plating technique, or an atomic layer deposition technique. For example, if the atomic layer deposition technique is used, a first magnetic layer 50 having a sub-nanometer-unit thickness may be formed because deposition in units of a mono-atomic layer is possible. In this way, the first magnetic layer 50 is formed along the stepped portion 411, resulting in a vertical thin film 501 stacked in a direction perpendicular to the horizontal surface of FIG. 5B, that is, the reference surface of the stacked structure.

Thereafter, as shown in FIG. 5C, the first magnetic layer 50′ is etched during a predetermined period of time to remove the horizontal portion of the first magnetic layer 50′, that is, to remain only the vertical thin film 501 that contacts the riser of the stepped portion 411, whereby the first magnetic portion 50 is formed. An anisotropic etching method may be used to etch the first magnetic layer 50′. An ion beam etching (IBE) method, a reactive ion etching (RIE) method, a reactive ion beam etching (RIBE) method or other methods may also be used to etch the first magnetic layer 50′. A possible etching direction is a vertical direction of FIG. 5C, that is, the direction approximately perpendicular to the reference surface of the stacked structure. However, it is typically known that etching efficiency may be better when ions are applied at 45 degrees than when ions are vertically applied. hence, first, ions collide with the first magnetic layer 50 at 45 degrees as indicated by an arrow \textcircled{1} to proceed etching. Then, to remove a portion of the first magnetic layer 50′ hidden by the stepped portion 411, the 45° angle is changed to a 90° angle to make the ions vertically collide with the first magnetic layer 50′ as indicated by arrow \textcircled{2}. The predetermined period of time may be a duration that is enough to remove the entire horizontal portion of the first magnetic layer 50′.

Then, as shown in FIG. 5D, an insulative material is deposited on the upper surfaces of the first insulation layer 41 and the first magnetic portion 50 and then polished until the upper surface of the first magnetic portion 50 is exposed. Hence, the second insulation layer 42 having the same level as the upper tread of the stepped portion 411 of the first magnetic portion 41 is formed. The third insulation layer 23 and the second magnetic layer 30 may be sequentially stacked on the resultant structure.

The formations of the second and third insulation layers 42 and 23 and the second magnetic layer 30 can be any processes as long as the first magnetic portion 41 and the second magnetic layer 30 are insulated from each other. In contrast with the present exemplary embodiment, the second magnetic layer 30 may be formed prior to the first insulation layer 41 with the subsequent processes being performed equally to the present exemplary embodiment.

FIG. 7 is a cross-section of a stacked structure for a magnetic recording head according to another exemplary embodiment of the present invention. As shown in FIG. 7, a stepped portion of the first insulation layer 41 has a predetermined inclination with respect to the vertical line, and etching may be performed at a predetermined inclination with respect to the vertical line, whereby a first magnetic portion 51 as a vertical thin film having an inverse-trapezoidal shape may be formed. In other words, the left inclination shown in FIG. 7 may be controlled to be equal to the riser of the stepped portion of the first insulation layer 41, and the right inclination may be formed by equalizing the direction in which ions collide with the first magnetic portion 51 to the direction indicated by an arrow. Therefore, the first magnetic portion 51 is made inverse-trapezoidal.

As described above, the method of manufacturing the magnetic recording head according to exemplary embodiments of the present invention can be executed using existing process equipment without changes.

A magnetic recording head according to an exemplary embodiment of the present invention has a new stacked structure which can remarkably reduce the track width of a magnetic recording medium. The track width of a magnetic recording medium is determined by the film thickness which can be more easily controlled as compared with photolithography.

Thus, the track width can be reduced to sub-nanometer.

Also, a magnetic recording head manufacturing method according to exemplary embodiments of the present invention can manufacture the magnetic recording head having the new stacked structure even by using existing process equipment without changes.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A magnetic recording head having a stacked structure including a main pole and a return pole, the stacked structure comprising:
a first insulation layer having a stepped portion on one surface;
a first magnetic portion having a shape of a vertical thin film that contacts a riser of the stepped portion; and
a second magnetic layer disposed to be insulated from the first magnetic portion.

2. The magnetic recording head of claim 1, wherein the stacked structure further comprises:
a second insulation layer formed on an upper surface of a lower tread of the stepped portion of the first insulation layer, having the same height as the first magnetic portion; and
a third insulation layer formed between an upper surface of the first magnetic portion and the second magnetic layer.

3. The magnetic recording head of claim 1, wherein the second magnetic layer is formed on a lower surface of the first insulation layer.

4. The magnetic recording head of claim 1, wherein the first magnetic portion is formed of a soft magnetic material having a greater saturation magnetic flux density than that of the second magnetic layer.

5. A magnetic recording apparatus comprising:
a magnetic recording head having a stacked structure including a main pole and a return pole; and
a magnetic recording medium in which a selected track travels in one direction with respect to the magnetic recording head,
wherein the stacked structure comprises:
a first insulation layer having a stepped portion on one surface;
a first magnetic portion having a shape of a vertical thin film that contacts a riser of the stepped portion; and
a second magnetic layer disposed to be insulated from the first magnetic portion; and
wherein the selected track of the magnetic recording medium travels in a direction perpendicular to a direction in which the first magnetic portion is stacked to form the magnetic recording head.

6. A method of manufacturing a magnetic recording head having a stacked structure including a main pole and a return pole, the method comprising:
forming a first insulation layer having a stepped portion on one surface;
forming a first magnetic layer, which is a magnetic thin film, on the first insulation layer along the stepped portion; and
forming a first magnetic portion by etching the first magnetic layer until only a vertical thin film portion of the first magnetic layer that contacts a riser of the stepped portion remains.

7. The method of claim 6, further comprising:
forming a second insulation layer by depositing an insulative material on upper surfaces of the first insulation layer; and
stacking a third insulation layer on an upper surface of the first magnetic portion; and
stacking a second magnetic layer on an upper surface of the third insulation layer.

8. The method of claim 6, wherein in the forming of the first magnetic portion by etching the first magnetic layer, etching is performed in a direction approximately perpendicular to a reference surface of the stacked structure using an anisotropic etching method.

9. The method of claim 8, wherein the anisotropic etching method is one method selected from the group consisting of an ion beam etching (IBE) method, a reactive ion etching (RIE) method, and a reactive ion beam etching (RIBE) method.

10. The method of claim 7, wherein in the forming of the second insulation layer, an insulative material is deposited on an upper surface of the first insulation layer and the first magnetic portion, and the insulative material is polished until the upper surface of the first magnetic portion is exposed.

11. The method of claim 6, further comprising:
etching the first magnetic layer using colliding ions at an angle of 45 degrees inclined with respect to a reference surface of the stacked structure, and changing the angle to an angle approximately perpendicular to the reference surface to etch a portion of the first magnetic layer hidden by the stepped portion.

12. The method of claim 6, wherein in the forming of the first insulation layer, the stepped portion is formed to have a predetermined angle with respect to a vertical line of a reference surface of the stacked structure, and in the forming of the first magnetic portion, etching of the first magnetic layer is performed so that the first magnetic portion has an inverse-trapezoidal shape.
